(19) United States
(12) Patent Application Publication
(10) Pub. No.: US 2009/0051253 A1
(43) Pub. Date: Feb. 26, 2009

(54) Printing Machine or Electrical Machine for a Printing Machine

(76) Inventor: Lothar Rettner, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/224,907

(22) PCT Filed: Feb. 12, 2007
(86) PCT No.: PCT/EP2007/051345

§ 371 Date: Sep. 9, 2008

(30) Foreign Application Priority Data
Mar. 22, 2006 (DE) 10 2006 013 636.5

(51) Int. Cl. H02K 19/12; G03G 15/00

(52) U.S. Cl. 310/40 R; 399/167

(57) ABSTRACT

There is described a printing machine or to an electrical machine for driving a cylinder of a printing machine, wherein the electrical machine has a primary part and a secondary part. The electrical machine has a disc-like primary part and a disc-like secondary part for forming a disc-shaped air gap or a cylindrical primary part and a cylindrical secondary part for forming a cylindrical air gap, wherein a primary part, which can be used for a linear motor, is also used for forming the cylindrical primary part.

### CROSS REFERENCE TO RELATED APPLICATIONS

This application is the US National Stage of International Application No. PCT/EP2007/051345, filed Feb. 12, 2007 and claims the benefit thereof. The International Application claims the benefits of German application No. 10 2006 013 636.5 DE filed Mar. 22, 2006, both of the applications are incorporated by reference herein in their entirety.

### FIELD OF INVENTION

The invention relates to a printing machine or an electrical machine, in particular for a drive device in the context of a printing machine. The electrical machine features a primary part and a secondary part, wherein both the primary part and the secondary part have a circular contour. Until now, direct drives in particular have been used as electrical machines for driving e.g. cylinders and rollers (also referred to as cylinders in the following) of a printing machine. These direct drives have a cylindrical air gap between the primary part and the secondary part. The larger the radius of such electrical machines, the greater the advantage in terms of the torque force which must be produced. In the case of printing machines, in particular, it is advantageous to use an electrical machine which can generate significant torque. It is also advantageous to use an electrical machine which has a particularly compact structural design. Until now, these two requirements relating to the electrical machine have often conflicted with each other.

### BACKGROUND OF INVENTION

EP 1 129 847 A1 discloses an electrical machine for driving a cylinder of a printing machine, wherein said electrical machine features a primary part and a secondary part and said secondary part is designed in the manner of a disk. The primary part and the secondary part form an air gap between them. The primary part features primary part segments with windings, wherein the primary part segments form a part of a disk in each case. The primary part segments can be used for a linear motor.

WO 2004/110760 A1 discloses an electrical machine for driving a cylinder of a printing machine, said electrical machine featuring a primary part and a secondary part, wherein the primary part and the secondary part are designed in the manner of a cylinder and form a cylinder-like air gap between them. The primary part features primary part segments.

WO 2004/017497 A1 discloses an electrical machine which features a primary part and a secondary part. The primary part features primary part segments which in turn feature windings. The primary part segments can be replaced individually.

### SUMMARY OF INVENTION

The present invention addresses e.g. the problem of specifying an electrical machine which both features a compact construction and can be used to produce high torque forces.

This problem is solved by means of an electrical machine having the features according to an independent claim. Advantageous embodiments of the electrical machine are derived from the features according to dependent claims. A further solution to the stated problem is given by a printing machine having the features according to a further independent claim. Advantageous embodiments of the printing machine are derived from the features according to dependent claims.

An electrical machine which can be used for a drive device in the context of a printing machine has a primary part and a secondary part. The printing machine is e.g. a rotary printing machine, a flexographic printing machine or similar. The electrical machine is developed such that it features a disc-like primary part and a disc-like secondary part. The disc-like primary part and the disc-like secondary part are arranged relative to each other in such a way that a disc-like air gap is thereby produced between the primary part and the secondary part. The disc-like construction of the electrical machine differs from a cylindrical construction of an electrical machine in that, while a rotational movement can still be performed by the electrical machine, the magnetic fields across the air gap do not however experience a radial alignment relative to the axis of rotation, but an alignment that is parallel to the axis of rotation of the electrical machine. The disc-shaped electrical machine thus configured is comparable with a linear motor which is forced onto a circular path. The primary part features windings which can be exposed to a current, said windings being advantageously arranged in a region of the primary part and representing an outer region of the disc in relation to the disc form. Significant torque can therefore be achieved. The same applies to the parts which form the secondary part. The secondary part features permanent magnets, for example, which are positioned on the secondary part in the same radius region as the windings of the primary part. If the secondary part features merely means for carrying a magnetic field instead of the permanent magnets, said means having a toothed structure, this toothed structure is also positioned on the secondary part in such a way that the toothed structure lies opposite that part of the primary part which is provided for producing the electromagnetic fields.

In a further embodiment, the electrical machine is configured such that the primary part features segments. The segments feature windings through which electrical current is to be passed. In an advantageous embodiment of the segments, said segments are primary parts of linear motors. Such primary parts usually feature a right-angled contour.

In a further embodiment of the electrical machine, the segments are arranged in the form of a polygon, wherein in particular an approximately circular contour is formed as a result of the polygon-like arrangement. As a result of this configuration, it is possible to produce a disc-shaped configuration of the air gap of the electrical machine.

An electrical machine can be realized not only in the form of a disc, this having a disc-like primary part and a disc-like secondary part for forming a disc-shaped air gap, but also as an electrical machine which has a cylinder-like primary part and a cylinder-like secondary part for forming a cylindrical air gap, wherein a primary part which can be used for a linear motor is also used for forming the cylinder-like primary part.

In particular, the electrical machine is of the type of a synchronous machine.

The disc-shaped structural design allows a particularly compact construction. This compact construction also allows the electrical machine to be positioned between a cylinder and a side wall supporting the cylinder. The side wall serves as a support element for the cylinder or its shaft.

The use of primary parts which might be designed for deployment in a linear motor also allows a flexible construction of the electrical machine. This is possible in particular because such primary parts of electrical linear motors are designed for individual assembly or for individual connection.

The disc-shaped configurations of the electrical machine or the resulting circular contour of the primary part or secondary part, and the corresponding circular arrangement of the segments by virtue of a polygon-like positioning, relate to the region of the air gap of the electrical machine. The electrical machine, which has e.g. a housing, can have various contours and layouts in terms of its housing, wherein these can have a circular, rectangular or other shape.

In particular, the primary part segment(s) for forming the primary part of the electrical machine have a dedicated electrical interface. Furthermore, individual primary part segments can easily be assembled or disassembled using separable connections such as e.g. screw connections, clamped connections or similar. For this purpose, the primary part segment has in particular holes for accommodating a screw. In a further embodiment of the primary part segment, this has a dedicated encapsulation. The windings that are laid in the core stack of the primary part segment are therefore encapsulated. This is typical for a primary part of a linear motor.

Unlike a conventional electrical machine, in which the stator and the rotor constitute one element in each case, the electrical machine advantageously features a primary part which is constructed from a plurality of linear motor components. In this case, the linear motor components which represent the segments of the primary part or of the secondary part can advantageously be attached to any diameter of a cylinder, for example, wherein said diameter is advantageously not too small. The secondary part is e.g. attached to a mobile part, this being the element which can be caused to rotate. The primary part is then correspondingly attached to an element which is fixed relative thereto.

The electrical machine can therefore advantageously be constructed from a plurality of individual segments. The air gap of the electrical machine can be either disc-shaped or cylindrical in this case.

The segments of the primary part, i.e. the primary part segments, are active parts of the electrical machine, wherein these advantageously resemble those of a conventional linear motor as described above. This conventional linear motor can be e.g. straight or cuboid in design. In order to increase the power of the electrical machine, provision can also be made for a dual-cam implementation.

If the electrical machine has a large diameter, i.e. a diameter of >1 m or even >2 and more, it is also possible to use conventional linear motor secondary parts (straight, cuboid) without the losses becoming too great, particularly in the case of a cylindrically constructed motor. This is because the air gap changes, due to chord formation, do not have a significant effect on the power of the electrical machine.

In order to optimize the power output, in an advantageous modification of the primary part of a conventional linear motor, it is possible to implement the primary part segment with an arced shape. The arced shape relates in particular to that side of the primary part segment which is oriented towards the air gap. As a result of the arced shape, a cylindrical construction of the electrical machine can be achieved in a simple manner. The arced shape is achieved in particular in that the core stack of the primary part segment has an arced shape. A circular shape is produced by stringing together a plurality of primary part segments having an arced shape.

The secondary part of the electrical machine can be implemented as a passive part, wherein this is also dependent on the size of the diameter and is arced corresponding to the primary part in accordance with the structural shape (cylindrical or disc-shaped).

In order to increase the power of the electrical machine and/or to neutralize the outwards-acting force of attraction between the primary and secondary part, the electrical machine with the disc-shaped air gap can be constructed as a so-called dual cam.

Furthermore, in order to increase the potential power of the electrical machine and/or to separate the functions “startup”, “fast mode”, etc., the primary part can be constructed from various primary part segments which are attached at different diameters or radiuses. This produces a nested arrangement of primary part segments and also of their associated secondary parts.

The secondary part of the electrical machine can be designed as a unitary part or as multiple parts, i.e. segmented.

A modular segmented construction of the electrical machine allows both flexible and economical planning and flexible and economical manufacture, assembly and disassembly. It is also advantageous that the power of the electrical machine can be increased or reduced subsequently. This is achieved by additionally assembling and connecting at least one additional primary part segment. The power can be reduced by removing a primary part segment. Since a primary part segment can be attached to a support separately in each case, and the primary part segment also features a dedicated electrical interface, a simple and economical repair is also possible if a part is to be replaced.

A printing machine, which is a flexographic printing machine in particular, can be constructed in a particularly compact manner as a result of using the electrical machine described here. Moreover, by means of using more or fewer primary part segments, it is possible to adapt the power of the electrical machine to the requirements of different printing machines in a simple manner.

The electrical machine is provided for driving a cylinder, in particular a printing cylinder, wherein provision is made for a shaft which is mounted relative to a support element, said support element being in particular a torque stay of the primary part or of the secondary part of the electrical machine. The support element can be embodied as a side wall, wherein the support element advantageously features a bearing for mounting the shaft of the cylinder.

The electrical machine is advantageously positioned between the support element and the cylinder. In the event that the cylinder is mounted by means of two support elements, provision can also be made for at least one electrical machine in each case between the support element and the cylinder. It is also possible to use only one electrical machine in the case of two support elements.

In a further embodiment, the electrical machine is positioned on a side of the support element, which side faces away from the cylinder.

Further varied embodiments of the electrical machine according to the invention are described below, wherein reference to these has already been made to some extent above.

In general, the primary part segment advantageously has at least one of the following features:
a dedicated electrical interface
an encapsulation
means for attachment of the primary part segment.

For ease of assembly, the primary part segment(s) can be attached to a support as a support device. Secondary part segments can also be separably or permanently attached to a further support device.

In an advantageous embodiment, the support device is also provided as a guiding device for guiding the mobile part of the electrical machine. The mobile part is either the primary part or the secondary part. With regard to the primary part, the primary part segments can also be guided individually or in groups by the guiding device.

As described above, a circular contour is produced by the arrangement of the segments, in particular the primary part segments. The primary part segments and/or the secondary part segments are therefore arranged e.g. in the form of a polygon, wherein a circular contour is produced by the polygon-like arrangement.

In an advantageous embodiment, the primary part of the electrical machine is configured in a polygon-like circular manner, wherein the secondary part has better circularity than the primary part. As a result of this, primary parts of a linear motor can be used as primary part segments without the harmonic properties of the electrical machine being unnecessarily degraded.

In a further embodiment, the primary part segment has a core stack, wherein the core stack has grooves for accommodating the windings, wherein the grooves are in particular arranged parallel with each other.

The secondary part can be configured in such a way that it features permanent magnets, these being positioned adjacently with an angular offset and in particular such that this results in a circular form.

In order to allow the manufacture of economical secondary parts, the electrical machine can also be configured such that it is in particular a synchronous machine, wherein the primary part features windings as a first means for generating a first magnetic field and the secondary part features means for guiding the magnetic field, wherein the primary part features at least one further means for generating a further magnetic field, wherein in particular the first means for generating the first magnetic field is arranged relative to the further means for generating the further magnetic field in such a way that a superimposition of the first magnetic field and the further magnetic field is possible. The means on the secondary part side, said means being provided for guiding a magnetic field, features a toothed structure in this context.

In the case of electrical machines which do not have to be fully equipped with primary part segments at the circumference, a type of electrical machine is suitable in which the secondary part does not have any permanent magnets or even electrical windings. The secondary part does however have means for guiding a magnetic field. This type has the advantage that it is economical and that it is possible to avoid the often unwanted magnetic field of conventional synchronous linear motor secondary parts which are equipped with permanent magnets. The assembly can be simplified in this manner. This type, which can also be implemented in the case of primary parts which are fully equipped with primary part segments over the circumference, is described below.

In the case of the electrical machine of this type, the primary part is embodied such that it has two means for generating a magnetic field. The secondary part is free of means for generating a magnetic field. The primary part therefore has a first means for generating a magnetic field and a further means for generating a magnetic field, wherein the first means for generating a magnetic field can be subjected to an alternating voltage or an alternating current. The first means for generating a magnetic field, which is a first magnetic field, is e.g. a winding. The further means for generating a magnetic field, which is an excitation field, is a means whereby a further, i.e. at least a second, magnetic field can be generated. The field excitation which generates the further magnetic field is advantageously unmodified, i.e. constant, during operation. Such a further means for generating the further magnetic field is e.g. a permanent magnet or a winding which is or can be subjected to a constant current. The further means for generating a further magnetic field advantageously features a multiplicity of further means for generating a magnetic alternating-flux field excitation.

The first means for generating a first magnetic field is e.g. a coil winding, wherein the first magnetic field, which leaves or enters the coil, is carried to further means (i.e. second, third, etc.) for generating further magnetic fields, such that at least two further means for generating further magnetic fields lie in the field region of the first magnetic field, and therefore an interaction of the two magnetic fields occurs. The further means for generating further magnetic fields advantageously feature a multiplicity of mutually opposite magnetization directions, thereby producing an arrangement having an alternating-flux magnetization.

The electrical machine, which has a primary part and a secondary part, wherein the primary part has a first means for generating a first magnetic field and the secondary part has a means for guiding the magnetic field, is therefore configured such that the primary part has at least two further means for generating at least two further magnetic fields, wherein the first means for generating the first magnetic field is arranged relative to the further means for generating the further magnetic fields in such a way that a superimposition of the first magnetic field and the further magnetic fields is possible.

Such a construction of the electrical machine has the advantage that the secondary part of the electrical machine does not have any active means for generating a magnetic field. The secondary part of such an electrical machine merely has a means for guiding magnetic fields and is therefore simple and economical to manufacture. The secondary part is embodied e.g. in a laminated manner in order to prevent eddy currents.

Soft iron parts can advantageously be used for the structural construction of primary part and secondary part. The lamination of these parts reduces eddy currents. In further embodiments, the soft iron parts can also take the form of solid and/or so-called pressed-powder parts.

The machine type can also be embodied such that the electrical machine has a primary part and a secondary part, and the primary part has a first means for generating a first magnetic field and furthermore a further means for generating a further magnetic field, wherein the first means is a winding and the further means is at least one permanent magnet. The further means is in particular a multiplicity of means, i.e. a multiplicity of permanent magnets. In the case of such an embodiment of the electrical machine according to the invention, all means for generating a magnetic field are situated in the primary part. The secondary part merely has a means for guiding magnetic fields and is e.g. embodied such that it has teeth on the surface which is oriented towards the primary part. This means is in particular a ferriferous means such as a core stack, for example.

The secondary part and/or the primary part are e.g. embodied in such a way that they have teeth. A tooth pitch of the secondary part and a tooth pitch or magnet pitch of the primary part can be either identical or different. In the case of identical pitch, for example, coils of a motor winding phase are grouped and arranged with an offset of 360°/m relative to further coil groups of the other motor winding phases. “m” designates the number of phases or winding phases. The tooth pitch of the secondary part (Tau_Sek) determines the pole pitch of the machine (Tau_p) and it applies that Tau_tooth,sek=2*Tau_p.

In an embodiment of the electrical machine, the tooth pitch of the secondary part is e.g. a whole-number multiple of the magnet pitch of the primary part. However, the electrical machine can also be configured such that the tooth pitch of the secondary part is not a whole-number multiple of the magnet pitch of the primary part.

The permanent magnets can be integrated in the primary part such that coils (windings) and magnets (permanent magnets) are packaged in the same part (primary part) of the electrical machine. In the case of a short stator structural design, considerably less magnetic material is required in comparison with the known motor principle. The secondary part advantageously consists solely of an iron reaction rail.

In a further advantageous embodiment of the electrical machine, the further means for generating a magnetic field (e.g. a permanent magnet), which is embedded in magnetically soft magnetic circuit sections, is arranged in a flux-concentrating manner. The flux-concentrating arrangement allows a high magnetic loading of the electrical machine. Embedding is understood to signify a positioning of the permanent magnets in magnetically soft material such that a magnetically soft material wholly or partially adjoins the sides of the permanent magnets at which the magnetic field emerges.

In a further embodiment of the electrical machine, its secondary part has at least one means for magnetic loopback. Said means has a core stack, for example. It is moreover advantageous to configure the secondary part such that it is free from magnetic sources. Magnetic sources are, for example, permanent magnets or also windings which are exposed to (electrical) current.

In a further embodiment, the secondary part is configured such that it features teeth which are oriented towards the primary part. The main flux is therefore guided within the secondary part via the teeth and via the loopback that may be present. Concerning the guidance of the flux via the teeth, the flux can only be guided e.g. via one tooth or via at least two teeth in each case.

As described above, the first means for generating a first magnetic field is advantageously a winding which can be exposed to a current. Such a winding of a machine consists of one or more winding phases (e.g. U, V, W). Each winding phase consists of one or more coils. An advantageous embodiment of the coils is characterized in that use is made of concentrated coils which are wound around one tooth in each case (tooth-wound coils), wherein the tooth can carry one or more poles or permanent magnets. The tooth-wound coil is at least one part of a winding in this case. The coil can be embodied as a single coil or as a split coil. The advantage of the winding is that it can be used to produce a changing magnetic field in the simplest manner, e.g. by means of an alternating current. The electrical machine can also be embodied e.g. such that it features a plurality of windings or coils, wherein these windings can be exposed to a current by various phases of a three-phase current source.

An electrical machine can also be embodied in such a way that a secondary part features teeth which are arranged such that they have a pitch distance Tau_Sek relative to each other. The primary part of the electrical machine contains the second means for generating a magnetic excitation field, which is realized from a multiplicity of the means (e.g. many permanent magnets), these being arranged such that they have a pitch distance Tau_Prim relative to each other.

An embodiment of the electrical machine is characterized in that the relationship between Tau_Sek and Tau_Prim can be expressed using the following equation:

Tau_{—}Sek=n*Tau_{—}Prim where n=1, 2, 3, . . .

Tau_Sek can therefore be expressed as a whole-number multiple of Tau_Prim.

In the case of a further embodiment of the electrical machine, the relationship between Tau_Sek and Tau_Prim can be expressed using the equation:

Tau_{—}Sek≠n*Tau_{—}Prim where n=1, 2, 3, . . .

The pitch distance Tau_Sek is therefore not a whole-number multiple of the pitch distance Tau_Prim.

As described above, a further embodiment of the electrical machine features permanent magnets as further means for generating at least one second magnetic field. The permanent magnets are advantageously arranged on the primary part such that they generate a magnetic excitation field in different directions in each case.

In an embodiment of the arrangement of the permanent magnets, the magnetization directions of the permanent magnets are parallel but alternately opposite.

In a further embodiment of the electrical machine, said machine has one primary part and two secondary parts. The primary part is arranged between the two secondary parts. This arrangement configured such that a magnetic circuit, which is formed by a magnetic useful flux, closes via the primary part and both secondary parts.

In the case of a further embodiment of the electrical machine, said machine has two primary parts and one secondary part. The secondary part is arranged between the two primary parts. The primary parts and the secondary part can be configured such that a magnetic circuit, which is formed by a magnetic useful flux, closes via the two primary parts and the secondary part.

However, the primary parts and the secondary part can also be configured such that a magnetic circuit, which is formed by a magnetic useful flux, closes via a primary part and the shared secondary part in each case.

### BRIEF DESCRIPTION OF THE DRAWINGS

Examples of inventive embodiments of electrical machines according to the invention and their use in the context of printing machines are shown in the following figures, in which:

FIG. 1 shows a printing machine,

FIG. 2 shows a disc-shaped electrical machine,

FIG. 3 shows a section of a disc-shaped electrical machine,

FIG. 4 shows a section of a cylindrical electrical machine, in cross section, including straight primary part segments,

FIG. 5 shows a section of a cylindrical electrical machine, in cross section, including arced primary part segments,

FIG. 6 shows a position of a disc-shaped electrical machine for driving a printing cylinder,

FIG. 7 shows a position of a cylindrical electrical machine for driving a printing cylinder,

FIG. 8 shows a schematic representation of a linear motor,

FIG. 9 shows a linear motor including permanent magnets on the primary part,

FIG. 10 shows a first course of magnetic fields in the linear motor,

FIG. 11 shows a second course of magnetic fields in the linear motor,

FIG. 12 shows a temporal course of flux, induced voltage and power,

FIG. 13 shows an illustration of the development of force,

FIG. 14 shows the geometry and field pattern of a linear motor having a transverse flux,

FIG. 15 shows a perspective view of a linear motor having a direct-axis flux,

FIG. 16 shows a linear motor with a primary part featuring a pole shoe,

FIG. 17 shows the geometry and field pattern of a linear motor having a direct-axis flux,

FIG. 18 shows a linear motor with different winding phases for different phases,

FIG. 19 shows the geometry and field pattern of a linear motor with tooth magnets in flux concentration,

FIG. 20 shows the geometry and field pattern of a linear motor with yoke magnets in flux concentration,

FIG. 21 shows a comparison of a primary part having a transverse flux magnetic circuit and a primary part having a direct-axis flux magnetic circuit,

FIG. 22 shows a comparison of electrical machines having an alternating-flux arrangement and a unidirectional-flux arrangement,

FIG. 23 shows an electrical machine having secondary parts arranged on both sides,

FIG. 24 shows an electrical machine having primary parts arranged on both sides,

FIG. 25 shows a magnetic field course of a transverse flux magnetic circuit arrangement, which is produced by an electric current.

### DETAILED DESCRIPTION OF INVENTION

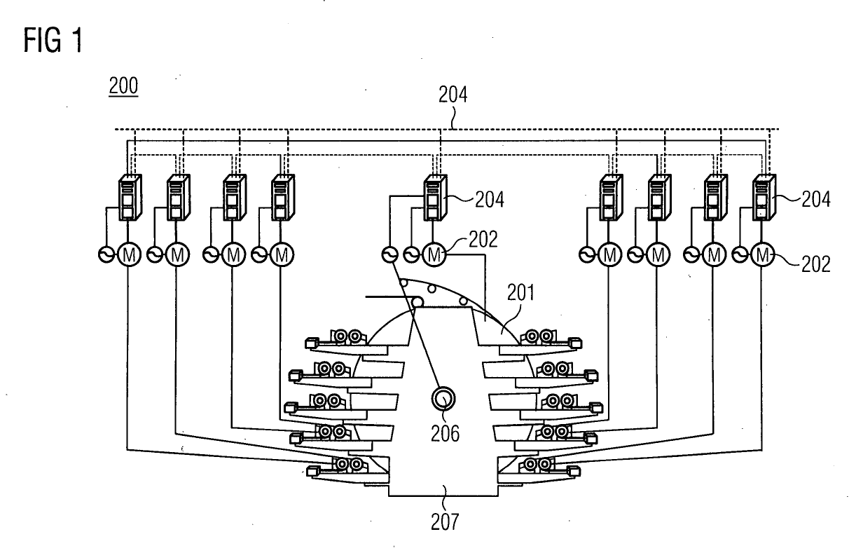

The illustration according to FIG. 1 shows a printing machine 200, in particular a flexographic printing machine in accordance with the prior art, which features a bus system 205, a printing cylinder 201, an electrical machine 202 for driving the printing cylinder 201, further electrical machines 203 for driving further cylinders, and power converters 204 for the electrical machines 202, 203.

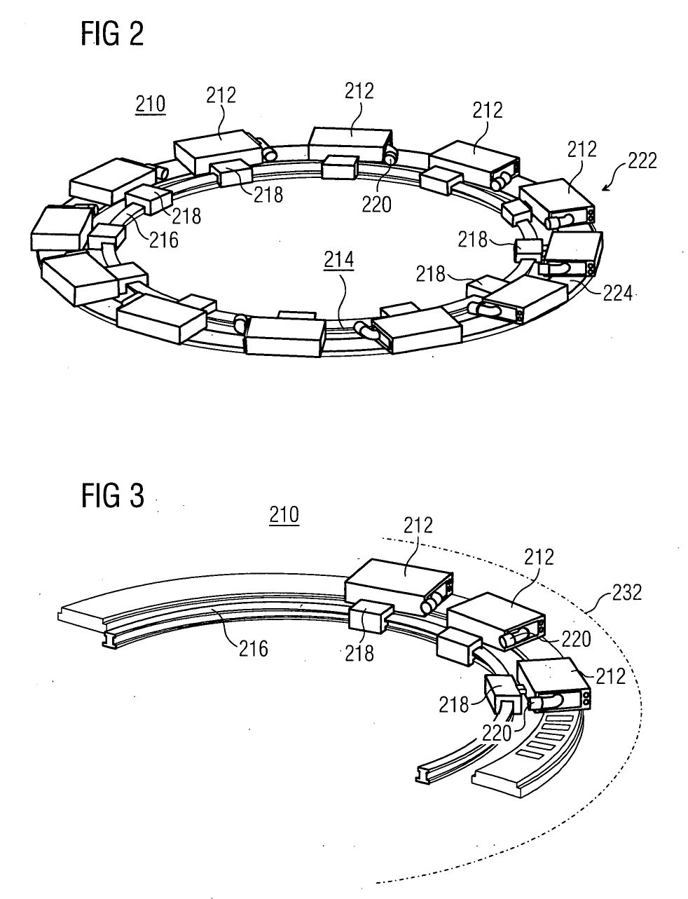

The illustration according to FIG. 2 shows a disc-shaped electrical machine 210 having a disc-shaped air gap. This machine features primary part segments 212. The primary part segments 212 are guided by means of a support device 214. The support device 214 features a guide bar 216 and slide blocks 218 which are guided thereon. The slide blocks 218 are mechanically connected to the primary part segments 212. The primary part segments 212 are separated from each other by means of spacers (not shown). Each of the primary part segments 212 features a dedicated electrical interface 220. The primary part segments 212 serve to form a primary part 222. A secondary part 224 is assigned to the primary part 222. The secondary part 224 can be configured as a rotationally symmetrical iron reaction rail, wherein the secondary part 224 can be configured as a unitary part or as multiple parts, i.e. segmented. The primary part segments 212 are advantageously formed of straight linear motor stators and arranged annularly. A circumference of the electrical machine is derived therefrom. FIG. 2 illustrates an annular torque motor comprising straight stator elements and a rotationally symmetrical secondary part.

The illustration according to FIG. 3 sectionally shows an electrical machine similar to that in FIG. 2, wherein the electrical machine (210) features fewer primary part segments 212 and the secondary part 224 now also features permanent magnets 226. In FIG. 2, the permanent magnets are integrated in the primary part segments 212. In the illustration according to FIG. 3, the position of a further disc-shaped electrical machine is also shown by means of a broken line 232. This further disc-shaped electrical machine, which is not shown, has a larger circumference than the disc-shaped electrical machine 210 in the illustration. The inner circumference of the disc-shaped electrical machine which is not shown must be smaller than the outer circumference of the electrical machine 210 in the illustration, in order that both can be positioned on approximately the same plane.

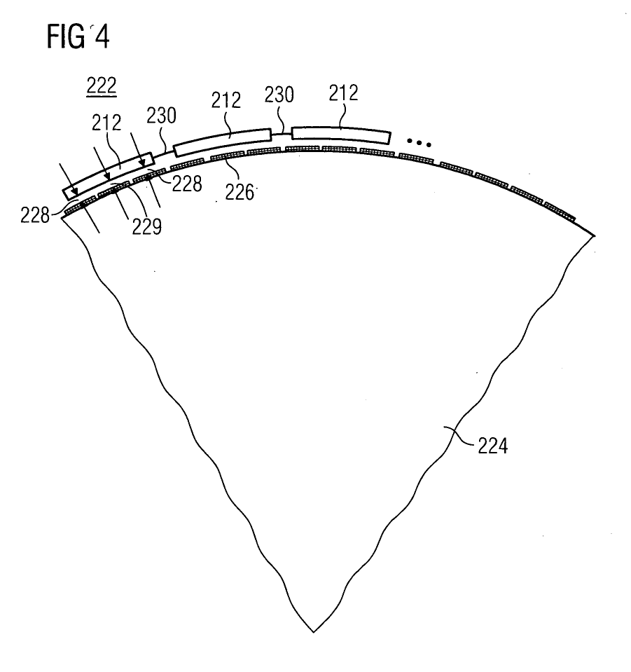

The illustration according to FIG. 4 shows a section of an electrical machine having a cylindrical basic shape in cross section. The secondary part 224 features permanent magnets 226. The primary part 222 features straight primary part segments 212, these being connected together by means of connection elements 230. As a result of the straight embodiment of the primary part segments 212, different air gap thicknesses 228, 229 are produced. Midway along the primary part segment 212, the air gap 229 is smaller than at the outer regions of the straight primary part segment 212, where a larger air gap 228 is present.

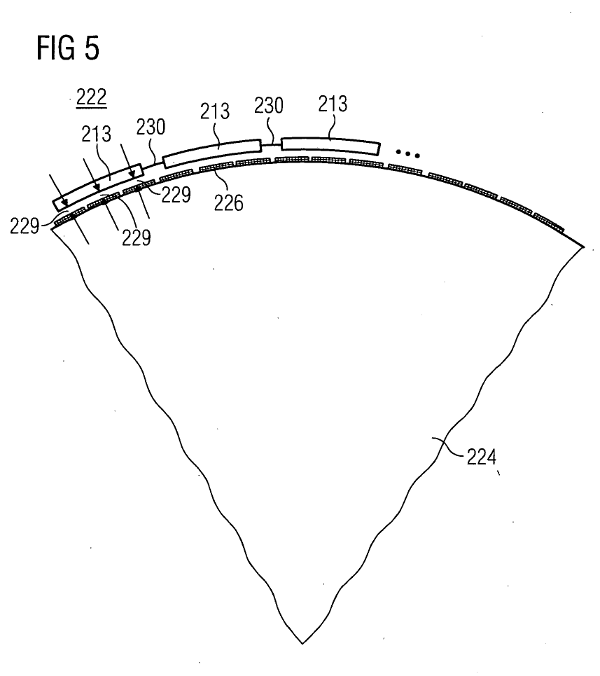

In contrast with FIG. 4, the illustration according to FIG. 5 shows arced primary part segments 213. As a result of the arc-shaped curvature, the air gap 229 between the primary part 222 and the secondary part 224 is identical, independent of the primary part segment 213.

When it is necessary to drive components having relatively large diameters, an electrical machine featuring segmented primary part segments offers e.g. the following advantages:
scalability of machine power due to modular construction;
flexible planning by means of variation of serial connection, parallel connection or individual connection of the primary parts to one or more power converters;
low manufacturing costs of the electrical machine in comparison with large electrical machines, since it is possible to use “standard components” which can be manufactured in large unit volumes using simple (existing) production means;
simple and inexpensive assembly of the machine at the equipment manufacturer or on site.

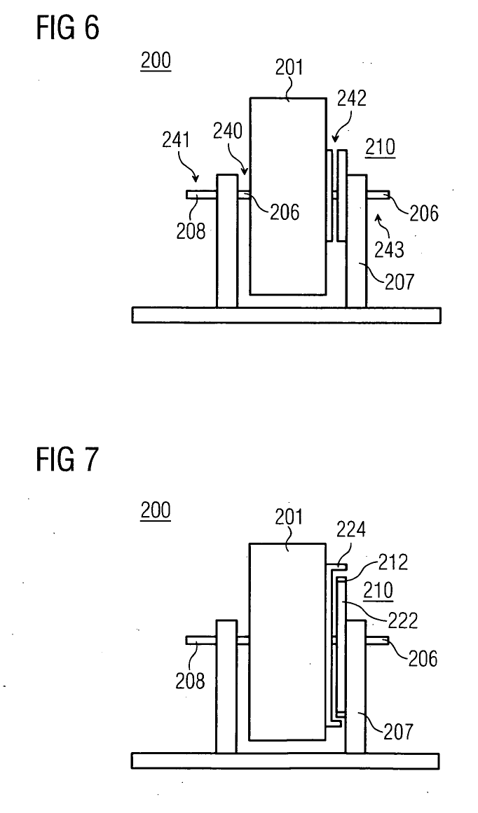

The illustrations according to FIGS. 6 and 7 show a printing machine 200 in simplified form. The printing machine 200 has one printing cylinder 201 which is rotatably mounted by means of a shaft 206. The mounting is done by means of support elements 207. The support elements 207 are side walls which feature a bearing for the shaft 206. The electric motor according to the invention can be constructed in a narrow manner such that it can be positioned between the support element 207 and the printing cylinder 201. In addition to this position 242 shown, further positions 240, 241 and 243 for the electrical machine are also possible in the region of a shaft end 208 but are not shown.

The illustration according to FIG. 6 shows an electrical machine 210 in a disc-shaped embodiment, wherein the secondary part 224, i.e. the passive part, is mechanically connected to the printing cylinder 201. The primary part 222, i.e. the active part, is mechanically connected to the support element 207. This has the advantage that the primary part, which carries the electrical interfaces, is stationary.

The illustration according to FIG. 7 shows an electrical machine 210 in a cylindrical embodiment, wherein the secondary part 224, i.e. the passive part, is likewise here mechanically connected to the printing cylinder 201. The primary part 222, i.e. the active part, is mechanically connected to the support element 207. This has the advantage that the primary part 222, which carries the electrical interfaces, is stationary. This cylindrically constructed electrical machine is constructed as an external rotor. In the case of the electrical machines shown in FIG. 4 and FIG. 5, the primary part segments are located at the outer circumference. According to FIG. 7, the primary part segments are located at the inner circumference of the electrical machine relative to the air gap. The electrical machine can therefore be configured in various variants.

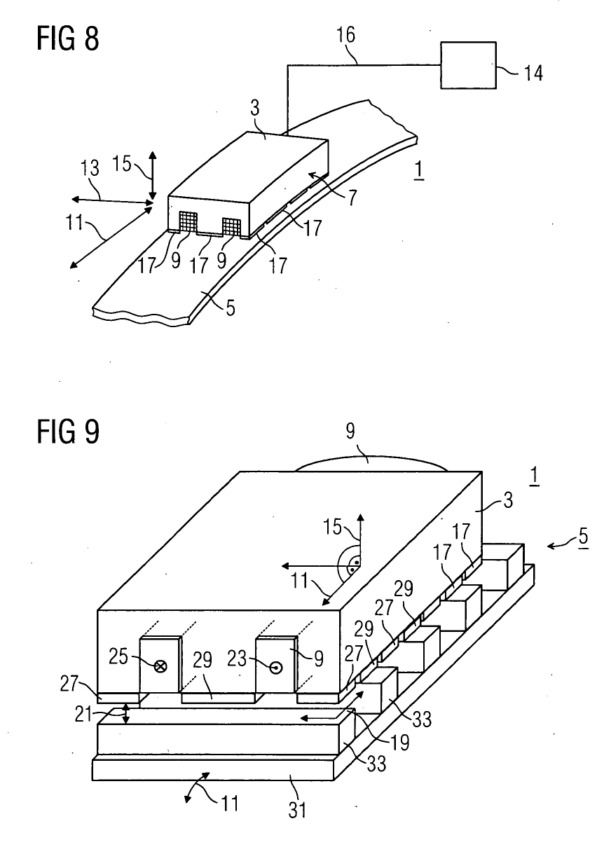

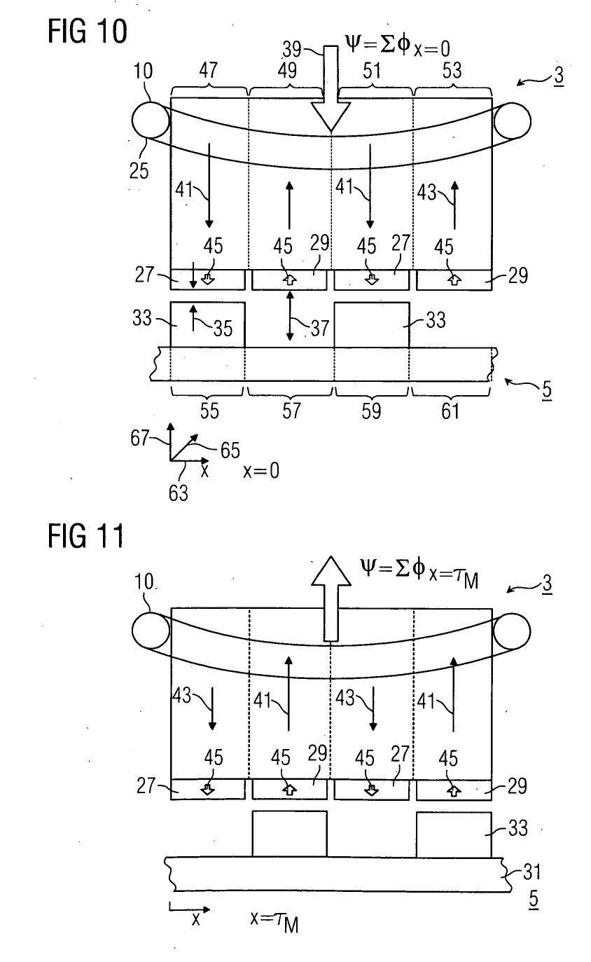

The illustration according to FIG. 8 shows an electrical machine 1. The electrical machine 1 features a primary part 3 and an arc-shaped secondary part 5. The secondary part 5 closes to form a circuit, wherein this is not illustrated. The primary part 3 features a winding 9 and permanent magnets 17. A first dual-headed arrow 11 indicates a direct-axis direction, wherein a further dual-headed arrow indicates the transverse direction 13. A third dual-headed arrow indicates the normal 15, wherein the normal relates to an air gap plane 19, wherein the air gap plane 19 is not shown in FIG. 8. However, the air gap plane 19 is shown in FIG. 9. An arrow indicates a side view 7 which relates to the illustration according to FIGS. 10 and 9. The electrical machine 1 is a linear motor which can be controlled by means of a power converter 14 that is connected via an interface cable 16.

In the following illustrations, the secondary part and the primary part are always designed straight in order to simplify the drawing. In the case of the electrical machine according to the invention, the primary part or the secondary part is always circular or disc-shaped or cylindrical in its design. In this way, segments of the primary part or secondary part can be straight or arced in their design.

The illustration according to FIG. 9 shows an electrical machine 1. The primary part 3 is designed as a core stack, wherein the primary part 3 features a winding 9. The winding 9 is a winding phase winding, wherein this can be exposed to an alternating current. The direction of the current at a given instant is shown in FIG. 9. In this case, the direction is indicated by means of a dot 23 or by means of a cross 25. The laminated primary part 3 features permanent magnets 17 on the side which faces the secondary part 5. The permanent magnets 17 are attached to the primary part in such a way that their magnetization alternates in the direction of the normal 15. The magnets (permanent magnets) therefore generate a magnetic flux which points alternately upwards (towards the primary part 3) and downwards (towards the secondary part 5). North-south permanent magnets (N-S) 27 (the magnetization direction points towards the secondary part) therefore alternate with the south-north permanent magnets (S-N) 29 (the magnetization direction points to the primary part). An air gap 21 is formed between the primary part 3 and the secondary part 5. This air gap 21 extends over the air gap plane 19. The movement of the electrical machine 1, which is a linear machine in the present case, takes place in the direction of the direct-axis direction 11. In this context, it is possible either for the primary part 3 to be stationary and the secondary part 5 to move or for the secondary part 5 to be stationary and the primary part 3 to move over the secondary part 5. The winding 9 is a first means for generating a first magnetic field and the permanent magnets 17 are further means for generating further magnetic fields.

The illustration according to FIG. 9 shows a transverse flux embodiment of the electrical machine 1. In the case of the transverse flux embodiment, the secondary part 5 is e.g. embodied such that it features a support 31 and crossbars 33. At least the crossbars 33 are laminated in their embodiment. The lamination takes place in such a way that sheet connects to sheet in an arced direct-axis direction 1. The crossbars 33 are e.g. adhered or soldered or welded onto the support 31, or connected to each other using a combination of attachment possibilities. The lamination is advantageous for the purpose of preventing eddy currents. If the negative eddy current effects are not very distinctive (e.g. in the case of applications having a sufficiently low electrical fundamental frequency), lamination can be omitted and economical solid parts can be used.

The illustration according to FIG. 10 shows a primary part 3 and a secondary part 5 in section. This section according to FIG. 10 schematically represents the manner in which magnetic fields can be divided in a primary part 3, wherein the form of a side view corresponding to a side view 7 according to FIG. 8 has been selected in this case. A turn of a winding 10 is shown in FIG. 10. It is also shown that the primary part 3 and the secondary part 5 can be divided into sections. The primary part features primary sections 47, 49, 51 and 53, wherein these primary sections 47, 49, 51 and 53 relate to the permanent magnets 27, 29. In this case, the sections are regions in which, depending on the magnetization direction of the permanent magnets 27 and 29, the magnetic flux runs either away from the secondary part 5 or towards the secondary part 5. The course is illustrated by means of arrows 41, 43. The sum of all magnetic fluxes linked by means of the winding 10 forms a linkage flux ψ. The linkage flux is primarily generated by the magnets, which can form a magnetic loopback via the secondary part 5. For each magnet, the flux arrows of different lengths show the flux that is linked by the winding (coil). The secondary part 5 also has sections corresponding to the crossbars 33 that are present. These secondary sections 55, 57, 59 and 61 therefore correspond to the sections in which a crossbar 33 is present or is not present. A magnetic flux can be guided by means of the crossbar 33. In the present example, the guidance of the magnetic flux takes place perpendicularly relative to an X-axis 63 which is illustrated. The flux therefore runs perpendicularly relative to the plane of the page on which the figure is represented, wherein this corresponds to a Y-axis 65. The Z-axis 67 is perpendicular to the X-axis and Y-axis 63, 65, such that all axes are perpendicular relative to each other. A magnetic excitation flux which is e.g. caused by a north-south permanent magnet 27, closes via the crossbar 33 and the primary part 3 in a section 47 in connection with the section 55. Behind a first north-south permanent magnet 27 (N-S permanent magnet), for example, the primary part 3 in this case features a further permanent magnet which is magnetized in an opposite direction, such that this is an S-N permanent magnet 29. Such a permanent magnet 29 is not illustrated in the FIG. 10, however, since it is posteriorly located. A narrow air gap 35 is produced at the positions where a crossbar 33 is situated opposite a permanent magnet 27, 29. A wide air gap 37 is produced at adjacent positions without a crossbar 33. By virtue of the air gaps 35 and 37 being different, magnetic fluxes 41 and 43 of different strengths are produced by permanent magnets 27 and 29 in sections 47,51 and 49,53. The resulting flux 39 is produced as the sum of all fluxes 41 and 43.

The illustration according to FIG. 11 shows the magnetic excitation flux 41, 43 relative to time at the instant and for the position of primary part 3 and secondary part 5 at which a current in the winding 10 has a zero crossing. The position-dependent course of the magnetic excitation flux or the induced voltage in the winding, and the converted power in this case of a motor that is exposed to a current, are illustrated in FIG. 10. A negative linkage flux v is produced for the position of the secondary part X=0 as illustrated in FIG. 10, and a positive flux ψ is produced for the position X=τ_{M} as illustrated in FIG. 11. The illustration according to FIG. 11 therefore shows the secondary part 5 in a position X=τ_{M}. If the secondary part 5 moves about a magnetic pole pitch, therefore, the flux linkage 39 of the coil (winding 10) gradually changes from a negative to a positive value as a result. The course of the change can be influenced by geometrical parameters such as magnet width, air gap, tooth width (width of the crossbars 33), etc. An advantageous embodiment aims to achieve a maximally sinusoidal change.

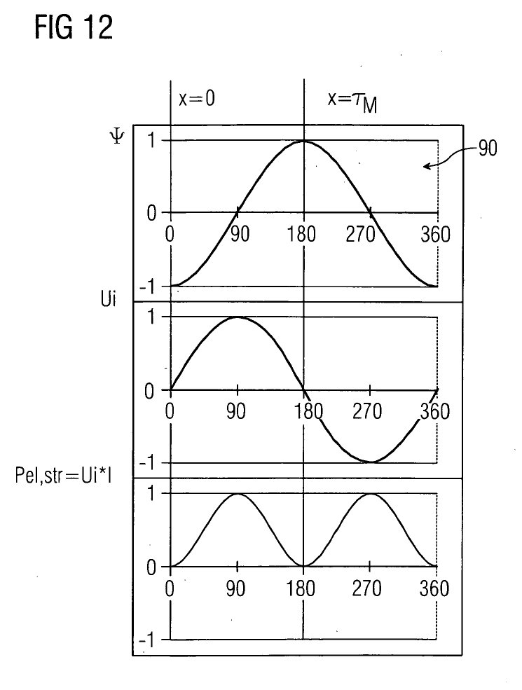

The illustration according to FIG. 12 comprises three graphs showing the magnetic linkage flux ψ, the resulting induced voltage Uᵢ and the electrical power P_{el,str} of a winding phase/winding in the temporal course. The temporal course is represented by specifying the phase position of the voltage. The course of the flux ψ also portrays the course of the magnetic field 90 which can be generated e.g. by means of permanent magnets. For the optimal force generation of a winding phase, the current must be injected in phase with the induced voltage. The positions X=0 and X=τ_{M} are also shown, wherein these positions, with the further illustrated courses of flux ψ, voltage Uᵢ and electrical power P_{el,str}, relate to the symbolic illustration according to FIGS. 10 and 11. It can be seen from the third graph, on which the electrical power is plotted, that the number of motor winding phases m must be greater than and/or equal to two for a constant power (˜ force). Three winding phases are advantageously selected, since three-phase converters require fewer semiconductor diodes than two-phase or multi-phase converters.

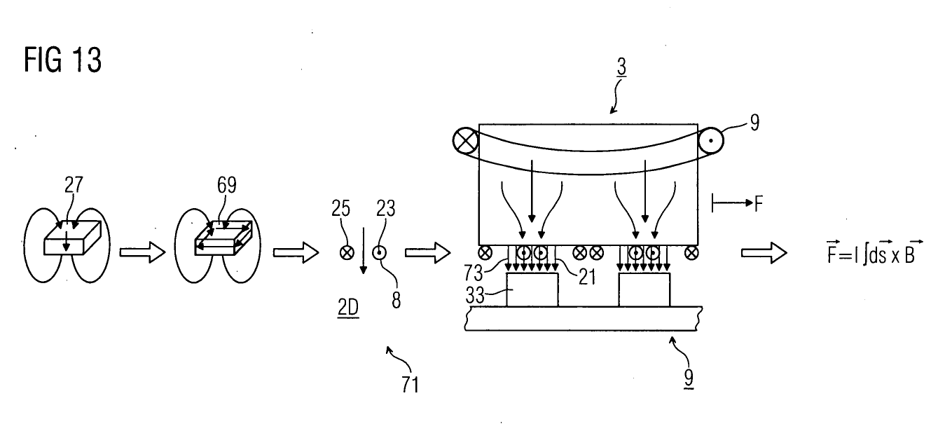

The illustration according to FIG. 13 serves to illustrate the technical principle and illustrates the generation of a force F. In order to clarify the generation of a force in a direct-axis direction of a linear motor, a utility model is introduced. A permanent magnet 27 is replaced by currents on a lateral surface belonging to said magnet. The permanent magnet 27 can therefore be notionally represented e.g. by a cuboid, wherein current flows as illustrated on the side surfaces of the cuboid 69. In a model 71, the permanent magnet 27 can therefore be represented by a winding, wherein the direction of the current within the winding is illustrated by a dot 23 or a cross 25 according to the model. In the illustration 2D, the magnet is reduced to the conductor cross section of the equivalent currents. If the magnets are now substituted in the side view of the primary part, the subsequent arrangement is produced. The magnetic field which is generated by the winding 9 is concentrated in the air gap 21 at the positions of the crossbars 33, which serve as flux concentrating pieces, since the magnetic resistance is lowest here. The fictive conductors therefore lie in the field of the winding phase coils, strengthening it on one side and weakening it on the other side. The conductors “move” into the region of lower field strength, this being illustrated by the direction of the force F acting on the primary part in FIG. 13. This relationship is also described by the “right-hand rule”, according to which the current, the magnetic field and the force F are situated in a right angle. The winding phase current, i.e. the current though the winding 9, reaches its maximum at the relative position X=τ_{M/2} of primary part 3 and secondary part 5 in FIG. 13.

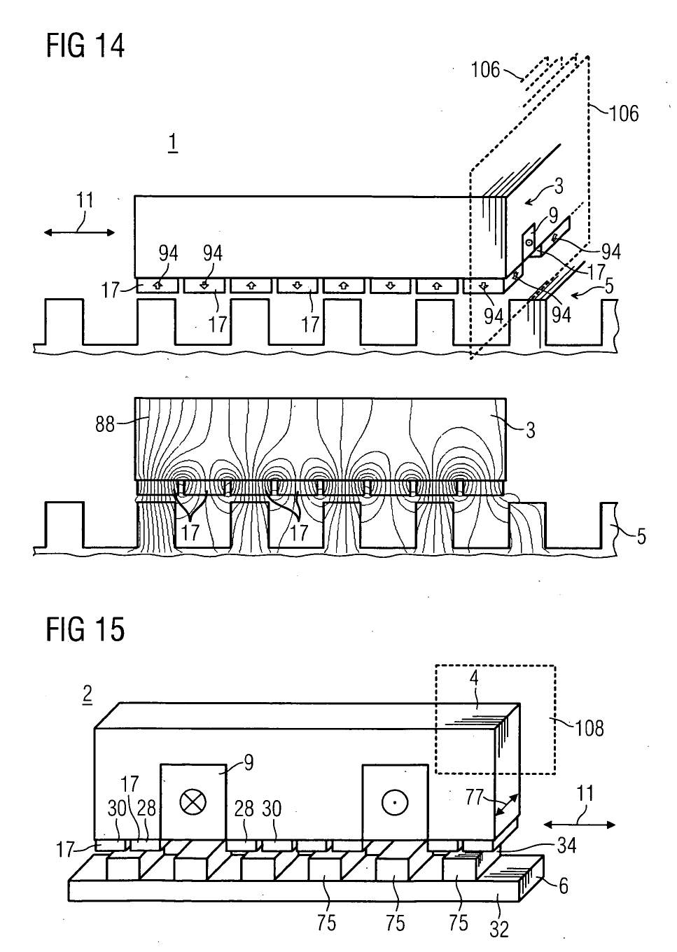

The illustration according to FIG. 14 schematically shows the geometry of a transverse flux linear motor 1 and a magnetic excitation field 88 which is generated by the permanent magnets 17. A magnetic useful flux is guided in a plane (106) which is oriented transversely relative to a direction of motion (11). The magnetic useful flux is the magnetic flux which is coupled or linked to the coil 9. This magnetic useful flux which is thus oriented forms a transverse flux magnetic circuit.

The excitation field 88 in FIG. 14 is the further magnetic field or the further magnetic fields. The linear motor 1 features a laminated primary part 3 and a laminated secondary part 5. The stacking direction of the core stacks is indicated in principle. The magnetization direction 94 of the permanent magnets 17 is illustrated by means of arrows. The possible direction of motion of the primary part is the direct-axis direction 11.

The illustration according to FIG. 15 shows a primary part 4 and a secondary part 6. The primary part 4 and the secondary part 6 form the electrical machine 2, wherein the electrical machine 2 features a direct-axis flux arrangement. The direct-axis flux arrangement is characterized in particular in that the magnetic fields do not close transversely relative to the direction of motion of the primary part or of the secondary part, but along the direction of motion of the primary part or of the secondary part. The magnetic flux, which is guided in a plane 108, wherein the plane 108 is oriented parallel with the direction of motion 11, is a magnetic useful flux. The magnetic useful flux is the magnetic flux which is coupled to the coil 9. This magnetic useful flux which is thus oriented forms a direct-axis flux magnetic circuit.

According to FIG. 15, the secondary part 6 is of laminated design in both the region of the support 32 and the region of the crossbars 34. The arrangement of the magnets in the air gap plane is not embodied in the form of a checkerboard as in the case of the transverse flux arrangement, but in the form of stripes. In the case of the direct-axis flux variant, the magnets are oriented essentially parallel with the crossbars (flux concentrating pieces). In order to reduce force wave effects, however, the magnets can be positioned appropriately in a type of oblique position.

In a further advantageous embodiment, the secondary part 6 is made of sheets which are stacked one behind the other over the width of the motor. In the case of such sheets, the support 32 and the teeth 75 consist of one part. The stacking of the sheets one behind the other results in the toothed structure of the secondary part with the crossbars 34. The type of lamination is indicated in FIG. 13. The secondary part can be constructed e.g. in multiple parts in a longitudinal direction, such that a secondary part 6 adjoins an adjacent secondary part. Such further secondary parts which adjoin in a direction of motion are not shown in the illustration according to FIG. 15, however. The illustration according to FIG. 15 additionally shows the permanent magnets. The permanent magnets are N-S permanent magnets 28 or S-N permanent magnets 30. These permanent magnets extend e.g. over an entire core stack width 77 of the primary part 4.

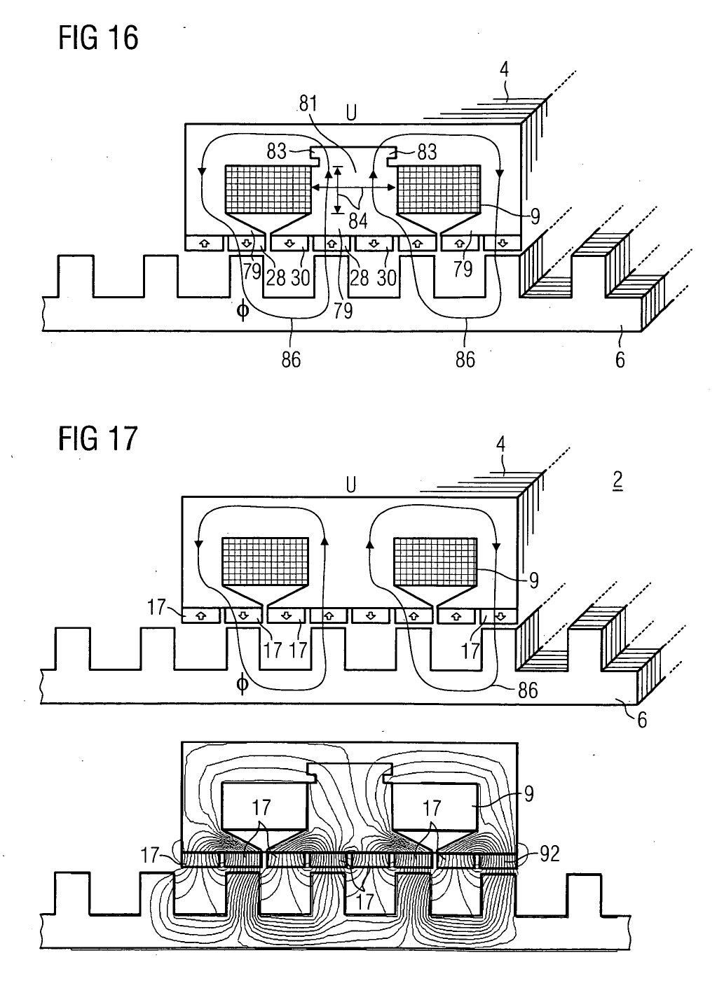

The illustration according to FIG. 16 shows a further development of an electrical machine 2 according to FIG. 15. In this case, the primary part 4 is configured such that it features pole shoes 79. The pole shoes 79 broaden the seating surface for permanent magnets 28, 30. The force output of the electrical machine 2 can be increased thus. Since the region in which a winding 9 can be laid in the primary part is narrowed as a result of enlarging the surface for positioning the permanent magnets, the primary part 4 is advantageously embodied such that it features a winding former 81. The winding former 81 features both a pole shoe 79 and a winding neck 84. The winding 9 can be wound around the winding neck 84 and then pushed into the primary part 4. The winding former 81 is advantageously secured in the primary part by means of lugs 83. In FIG. 16, the winding 9 is designated as winding phase U of a motor. Further motor winding phases (e.g. V and W) can be realized by means of identically constructed primary parts 4 but are not shown. In the position that is shown, the permanent magnets 28 and 30 generate the excitation fluxes 86 whose sum forms the flux linkage ψ of the coil 9. It can be seen from the illustration in FIG. 16 that the magnetic excitation fluxes 86, which represent a useful flux, form a direct-axis flux magnetic circuit.

The illustration according to FIG. 17 shows a linear motor 2 with a direct-axis flux magnetic circuit. This corresponds to the illustration according to FIG. 16. FIG. 17 additionally shows the distribution of the further magnetic fields 92 in an illustration in the lower part of the figure. These further magnetic fields 92 are the magnetic excitation field which is produced by the permanent magnets 17.

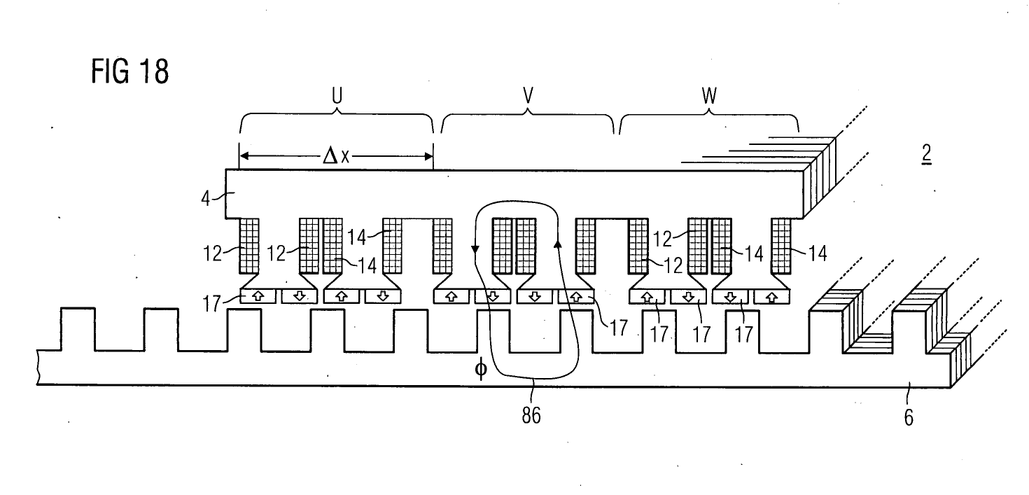

The illustration according to FIG. 18 shows a further exemplary embodiment of an electrical machine 2, wherein this can be constructed with three winding phases U, V and W at this stage. Each winding phase is provided for a phase of a three-phase network. The required phase shift is achieved by means of the geometric offset of the winding phases relative to each other. In this case, the geometric offset Δx corresponds to 120° electrically for the three-phase machine which is illustrated. FIG. 18 also differs from FIG. 17 e.g. in that each winding phase U, V and W is assigned not only one tooth-wound coil 9, but two tooth-wound coils 12 and 14 are assigned to a winding phase U, V and W in each case.

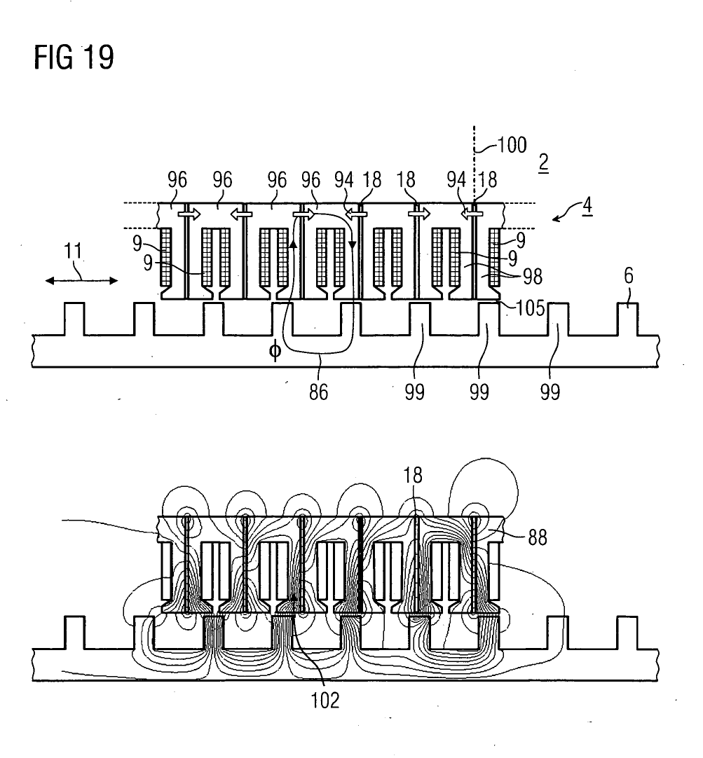

The illustration according to FIG. 19 shows an electrical machine 2 in the form of a linear motor, wherein tooth magnets 18 are used as permanent magnets here. The tooth magnets 18, which are also simply permanent magnets, are situated between e.g. laminated soft iron material 96. The further magnetic field 86 which is generated by the tooth magnets 18 is indicated by lines with arrows. The magnetization direction 94 of the permanent magnets 18 is likewise illustrated by means of arrows. The tooth magnets 18 are positioned essentially centrally in a tooth 98 and run essentially parallel with a coil axis 100 of the tooth-wound coil 9. The tooth 98 is surrounded by a tooth-wound coil 9. FIG. 19 shows the geometric construction in an upper half of the diagram, and the course of the magnetic excitation field 88 in a lower half of the diagram. The magnetic excitation field 88 is the further magnetic field which is generated by means of the tooth magnets 18. In this case, the illustration of the excitation field 88 clearly shows the effect of the flux concentration 102. The flux concentration is determined by the magnetic circuit geometry. In this case, influence variables are e.g. the magnet dimensions and the sheet sectional dimensions. The magnetization direction 94 of the tooth magnets 18 (the tooth magnet is a permanent magnet) is mainly parallel with an air gap plane of the air gap 105.

The tooth pitch of the secondary part 6 of the electrical machine 2 according to FIG. 19 is not a whole-number multiple of the magnet pitch of the primary part 4. This applies in particular to the average value if the tooth pitch or magnet pitch is not constant.

The coils 9 can be exposed to a current of one and/or more phases. The assignment of the coils to individual motor phases is dependent on the selected tooth pitch ratio between the primary part 4 and the secondary part 6. The illustration according to FIG. 19 shows a different tooth pitch for the teeth 98 of the primary part 4 than for the teeth 99 of the secondary part 6. In this case, a multi-phase electrical machine can be realized for both an equal and an unequal tooth pitch on the primary and secondary part. An equal tooth pitch is illustrated in FIG. 14 and FIG. 18 by way of example.

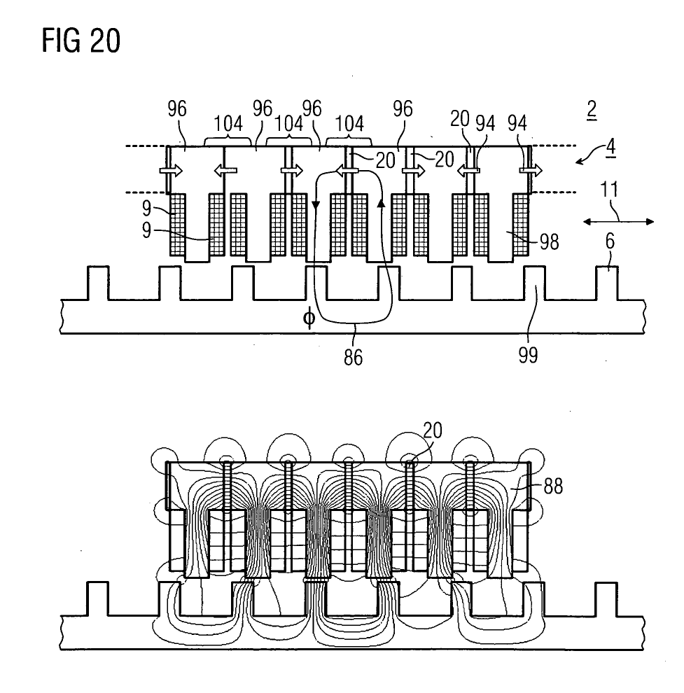

The illustration according to FIG. 20 differs from the illustration according to FIG. 19 essentially in that, instead of tooth magnets, yoke magnets 20 are now used a further means for generating further magnetic fields. The yoke magnets 20 are also permanent magnets and are positioned in the region of a yoke 104. The yoke 104 is used for connecting teeth 98. In comparison with FIG. 19, the positioning of the magnets also produces a different excitation field 88 in FIG. 20.

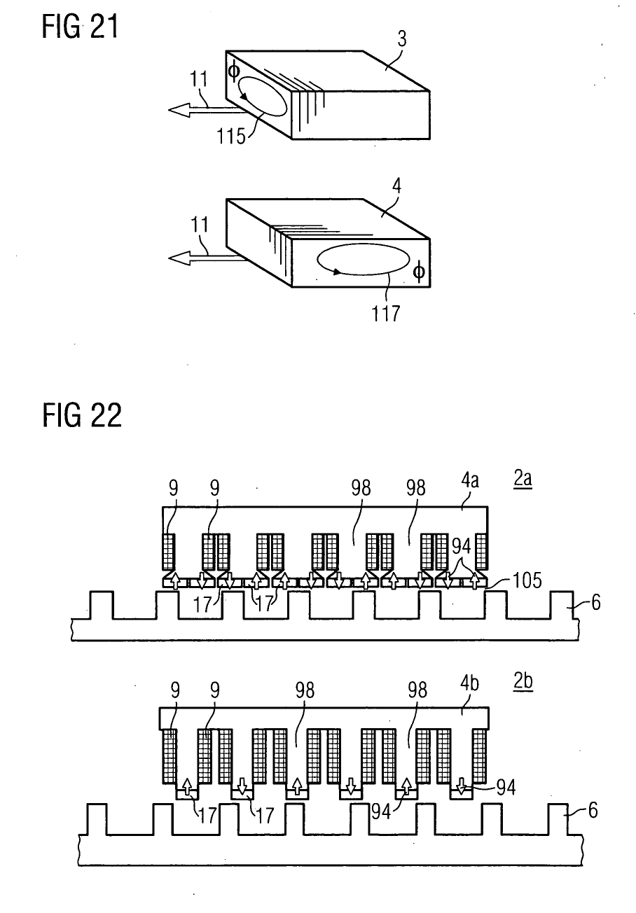

The illustration according to FIG. 21 schematically shows a comparison of a primary part 3 having a transverse flux magnetic circuit 115 and a primary part 4 having a direct-axis flux magnetic circuit 117. The primary parts 3,4 are in particular primary parts 3,4 of a permanent-field synchronous motor which features permanent magnets in the primary part, wherein the permanent magnets likewise are not illustrated in this figure. The magnetic flux Φ is shown only symbolically in each case. Further means for generating the magnetic flux Φ, e.g. windings that can be exposed to a current, are likewise not shown for reasons of better clarity. A possible direction of motion 11 is indicated by an arrow. A secondary part which is assigned to the relevant primary parts 3 and 4 is not illustrated in the FIG. 21. The illustration also shows that, with regard to a lamination of the primary parts 3 and 4, the embodiment of this depends on the orientation of the relevant magnetic circuit 115 and 117. In the case of the transverse flux magnetic circuit 115, the magnetic excitation flux Φ essentially closes in a plane which is oriented transversely relative to the direction of motion 11. The motor sheets that are used for lamination of the primary part 3,4 follow the flux plane and are e.g. stacked in a longitudinal extension of the primary part 3, wherein the longitudinal extension is the extension of the primary part 3 in the direction of motion 11.

The illustration according to FIG. 22 shows a comparison of electrical machines 2a and 2b, wherein both electrical machines 2a, 2b are linear motors. The electrical machine 2a has a primary part 4a featuring teeth 98, wherein permanent magnets 17 having a different magnetization direction 94 are attached to a tooth 98 in each case. The permanent magnets 17 are attached to that side of the primary part which faces an air gap 105. The magnetization direction 94 of the permanent magnets 17 is principally perpendicular to an air gap plane.

In accordance with FIG. 22, a tooth-wound coil 9 is wound around the teeth 98 in each case. Since each of the teeth 98 now has permanent magnets 17 with opposite magnetization directions 94, a magnetic alternating flux is produced when the primary part 4a moves relative to the secondary part 6. The electrical machine 2a therefore has an alternating flux arrangement. By virtue of the permanent magnets 17 which are used to form a (magnetic) excitation field, a magnetic alternating flux is generated in the magnetic circuit as a result of a relative movement of the secondary part 6 to the primary part 4a. The magnetization directions 94 of the individual permanent magnets 17 are therefore oriented such that a magnetic alternating flux is generated in the coil-bearing magnetic circuit sections of the primary part 4a as a result of a movement of the toothed secondary part 6.

The electrical machine 2b in FIG. 22 also has a primary part 4b featuring teeth 98. In contrast with the electrical machine 2a, the teeth 98 only feature one permanent magnet 17 for each tooth 98 in the case of the electrical machine 2b. Since the permanent magnet 17 has a magnetization direction 94, each tooth 98 is only assigned one magnetization direction 94. An electrical machine 2b can also be configured such that a tooth 98 features a plurality of permanent magnets, these nonetheless having the same magnetization direction relative to a tooth 98. This embodiment is not explicitly shown in FIG. 22. In the case of the electrical machine 2b, the magnetization directions 94 also alternate with the teeth 98 on the primary part 4b. Each tooth therefore has a different magnetization direction 94 alternately. Since the teeth 98 now feature permanent magnets 17 having opposite magnetization directions 94, a magnetic unidirectional flux is produced when the primary part 4b moves relative to the secondary part 6. The electrical machine 2b therefore has a unidirectional flux arrangement. By virtue of the permanent magnets 17 which are used to form a (magnetic) excitation field, a magnetic unidirectional flux is generated in the magnetic circuit as a result of a relative movement of the secondary part 6 to the primary part 4b. In the case of the electrical machine 2b in FIG. 22, the magnetization directions 94 of the individual permanent magnets 17 are therefore oriented such that a magnetic unidirectional flux is generated in the coil-bearing magnetic circuit sections of the primary part 4b as a result of a movement of the toothed secondary part 6, wherein the magnetic unidirectional flux does not change its direction and oscillates periodically between a maximal and a minimal value.

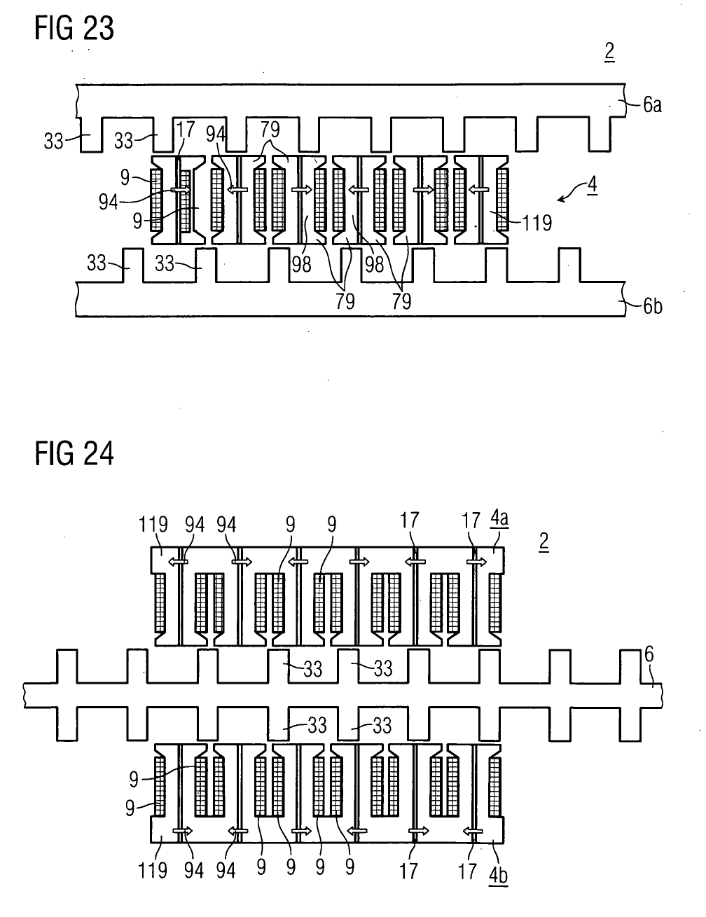

In the illustrations according to FIG. 22 or FIG. 19, an arrangement is selected in which a force effect can be achieved between a primary part and a secondary part. The illustration according to FIG. 23 shows an arrangement of an electrical machine which features a primary part 4 and two secondary parts 6a and 6b. A force effect is therefore produced between only one primary part 4 and two secondary parts 6a and 6b. This produces almost a two-fold increase in the force that can be generated. The teeth 98 of the primary part 3 of the linear motor according to FIG. 23 feature two pole shoes 79 in each case, wherein each pole shoe 79 is oriented towards a secondary part 6a or 6b. This embodiment of the electrical machine 2 according to FIG. 23 is a type of development of the electrical machine 2 according to FIG. 19. In this case, the double-sided arrangement of the secondary parts is not restricted to the embodiment of the primary part 4 shown in FIG. 23, in which the permanent magnets 17 are embedded in a magnetically soft material 119. It is also possible to implement primary parts which feature permanent magnets on the pole shoes. Such an embodiment is not shown in FIG. 23, however.

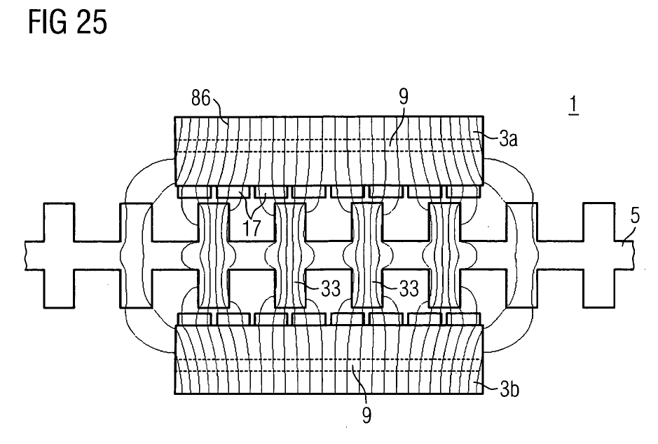

The illustration according to FIG. 24 shows an arrangement of an electrical machine 2 which features two primary parts 4a and 4b and only one associated secondary part 6. A force effect is therefore produced between only one secondary part 6 and two primary parts 4a and 4b. This produces almost a two-fold increase in the force that can be generated. The teeth 3 of the secondary part of the linear motor 2 according to FIG. 23 are oriented on both sides towards a single primary part 4a and 4b in each case. Teeth 33 of the single secondary part 5 are therefore assigned to each primary part 4a and 4b. This embodiment of the electrical machine 2 according to FIG. 24 is a type of development of the electrical machine 2 according to FIG. 19. In this case, the double-sided arrangement of the primary parts 4a and 4b is not restricted to the embodiment of the primary part 4a shown in FIG. 23, in which the permanent magnets 17 are embedded in a magnetically soft material 119. It is also possible to implement primary parts which feature permanent magnets on the pole shoes as in FIG. 17, for example. Such an embodiment is not shown in FIG. 24, however.

By way of example, the illustration according to FIG. 25 shows the magnetic field course in the case of an electrical machine 1 which features two primary parts 3a and 3b and one secondary part 5. The primary parts 3a and 3b feature permanent magnets 17 and a winding 9. The illustration according to FIG. 25 shows the magnetic flux 86 which is produced by means of a current through the winding 9 of the primary parts, said winding being shown by a broken line. In the case of the magnetic flux 86 illustrated in FIG. 25, the magnetic flux which is caused by the permanent magnets is not taken into consideration.

1-14. (canceled)

15. An electrical machine for driving a cylinder of a printing machine, comprising:
a primary part, wherein the primary part has primary part segments, wherein the primary part segments have windings, wherein primary parts which can be used for a linear motor are used as primary part segments, wherein the primary part segments have dedicated electrical interfaces, wherein the electrical interfaces have a separable electrical contact in each case; and
a secondary part, wherein the secondary part has secondary part segments, wherein either the primary part and the secondary part are configured in a disc-like manner and form a disc-shaped air gap between them or the primary part and the secondary part are configured in a cylinder-like manner and form a cylinder-like air gap between them.

16. The electrical machine as claimed in claim 15, wherein the primary part segment or the secondary part segment is separably attached to a support device.

17. The electrical machine as claimed in 15, wherein the primary part segments and the secondary part segments are arranged in the manner of a polygon, wherein an approximately circular contour is formed by the polygon-like arrangement.

18. The electrical machine as claimed in 15, wherein the primary part segments or the secondary part segments are arranged in the manner of a polygon, wherein an approximately circular contour is formed by the polygon-like arrangement.

19. The electrical machine as claimed in claim 15, wherein the secondary part and the primary part feature an approximately circular contour.

20. The electrical machine as claimed in claim 15, wherein the secondary part or the primary part feature an approximately circular contour.

21. The electrical machine as claimed in claim 19, wherein the approximately circular contour of the secondary part approximates a circle more closely than the approximately circular contour of the primary part.

22. The electrical machine as claimed in claim 15, wherein the primary part segment features a core stack, wherein the core stack features grooves for accommodating the windings, wherein the grooves are arranged parallel with each other.

23. The electrical machine as claimed in claim 15, wherein the electrical machine is a synchronous machine, wherein the primary part features windings as a first device for generating a first magnetic field and the secondary part features a device for guiding the magnetic field, wherein the primary part features at least one further device for generating a further magnetic field, wherein the first device for generating the first magnetic field is arranged relative to the further device for generating the further magnetic field in such a way that a superimposition of the first magnetic field and the further magnetic field is possible.

24. The electrical machine as claimed in claim 23, wherein the device provided on the secondary part side for guiding a magnetic field has a toothed structure.

25. The electrical machine as claimed in claim 15, wherein a guiding device is provided for guiding the primary part segments.

26. A printing machine, comprising:
an electrical machine with
a primary part, wherein the primary part has primary part segments, wherein the primary part segments have windings, wherein primary parts which can be used for a linear motor are used as primary part segments, wherein the primary part segments have dedicated electrical interfaces, wherein the electrical interfaces have a separable electrical contact in each case, and
a secondary part, wherein the secondary part has secondary part segments, wherein either the primary part and the secondary part are configured in a disc-like manner and form a disc-shaped air gap between them or the primary part and the secondary part are configured in a cylinder-like manner and form a cylinder-like air gap between them.

27. The printing machine as claimed in claim 26, wherein the electrical machine is provided for driving a cylinder, wherein provision is made for a shaft which is mounted relative to a support element, wherein the support element is a torque stay of the primary part or of the secondary part of the electrical machine.

28. The printing machine as claimed in claim 26, wherein the electrical machine is positioned between the support element and the cylinder.

29. The printing machine as claimed in claim 26, wherein the cylinder is mounted via two support elements, wherein in each case at least one electrical machine is positioned between the support elements and the cylinder.

30. The printing machine as claimed in claim 26, wherein the electrical machine is positioned on a side of the support element, which side faces away from the cylinder.

31. A flexographic printing machine, comprising:
an electrical machine with
a primary part, wherein the primary part has primary part segments, wherein the primary part segments have windings, wherein primary parts which can be used for a linear motor are used as primary part segments, wherein the primary part segments have dedicated electrical interfaces, wherein the electrical interfaces have a separable electrical contact in each case, and
a secondary part, wherein the secondary part has secondary part segments, wherein either the primary part and the secondary part are configured in a disc-like manner and form a disc-shaped air gap between them or the primary part and the secondary part are configured in a cylinder-like manner and form a cylinder-like air gap between them.

32. The flexographic printing machine as claimed in claim 31, wherein the electrical machine is provided for driving a cylinder, wherein provision is made for a shaft which is mounted relative to a support element, wherein the support element is a torque stay of the primary part or of the secondary part of the electrical machine.

33. The flexographic printing machine as claimed in claim 32, wherein the electrical machine is positioned between the support element and the cylinder.

34. The flexographic printing machine as claimed in claim 33, wherein the cylinder is mounted via two support elements, wherein in each case at least one electrical machine is positioned between the support elements and the cylinder.
